(19) United States
(12) Patent Application Publication
(10) Pub. No.: US 2009/0154157 A1
(43) Pub. Date: Jun. 18, 2009

(54) LIGHT EMITTING UNIT AND OPTICAL FILM ASSEMBLY THEREOF

(76) Inventor: Wen-Jyh SAH, Tainan City (TW)

Correspondence Address: BIRCH STEWART KOLASCH & BIRCH, PO BOX 747, FALLS CHURCH, VA, 22040-0747, US

(21) Appl. No.: 12/277,098

(22) Filed: Nov. 24, 2008

(30) Foreign Application Priority Data
Dec. 14, 2007 (TW) 096147989

(51) Int. Cl. G02B 5/02; F21V 5/02

(52) U.S. Cl. 362/235; 362/339

(57) ABSTRACT

An optical film assembly is applied to a light emitting unit which has at least two light sources for emitting light beams respectively. The optical film assembly includes a first prism element and a first diffusion element. The first prism element, which is a sheet thinner than 0.5 mm, has a first substrate and at least one first prism layer disposed on the first substrate. The first diffusion element, which is a sheet thinner than 0.5 mm, is disposed adjacent to the first prism element. The light beams are emitted to the first prism element or the first diffusion element directly. The light sources have a plurality of projection points which are projected to a light-emitting surface of the optical film assembly. The gain of each projection point is less than 1.

### CROSS REFERENCE TO RELATED APPLICATIONS

This Non-provisional application claims priority under 35 U.S.C. §119(a) on Patent Application No(s). 096147989 filed in Taiwan, Republic of China on Dec. 14, 2007, the entire contents of which are hereby incorporated by reference.

### BACKGROUND OF THE INVENTION

1. Field of Invention

The present invention relates to an optical film assembly and, in particular, to an optical film assembly for a direct-type light emitting unit.

2. Related Art

Since the liquid crystal display technology has been developed recently, the conventional CRT displays are gradually replaced by the LCD displays. In the LCD display, the liquid crystal can not emit light by itself, so a backlight module is needed to be the light source.

As shown in FIG. 1, a conventional backlight module 1 includes a plurality of light sources S, an optical film assembly 10 and a diffuser B. The light source S is a cold cathode fluorescent lamp (CCFL) for example, and the light sources S are separately arranged. The diffuser B is disposed on the light sources S, and the optical film assembly 10 is disposed on the diffuser B.

The diffuser B can scatter the light emitted from the light sources S of the backlight module 1, so that the diffuser B can achieve the function of a plane light source. The light sources S have an interval P, and the light source S and the diffuser B have a distance D. In the prior art, the ratio D/P must be larger than or equal to 0.65 so as to form a uniform plane light source without mura by the diffuser B. The definition of the “uniform plane light source” is to satisfy the condition that the ratio of the measured brightness of any point on the light-emitting surface of the diffuser B to the maximum measured brightness of the light-emitting surface of the diffuser B must be larger than or equal to 70%. The light emitted from the diffuser B has larger light shape, so that the optical film assembly 10 is configured on the diffuser B to adjust the light shape of the emitted light.

In general, the optical film assembly 10 includes a prism sheet 11 and diffusion sheets 12 and 12′, and the prism sheet 11 is disposed between the diffusion sheets 12 and 12′. Thus, after passing through the optical film assembly 10, the light from the diffuser B can have a light shape of a concentrated and uniform plane light source. In addition, the design of the backlight module 1 is based on the consideration of obtaining stronger light intensity at the place perpendicular to the light-emitting surface F, so that the gain of the projection point F1 of the light source S, which is projected to the light-emitting surface F of the optical film assembly 10, is greater than 1. The definition of the “gain” is the ratio of the light intensity of the projection point F1 perpendicular to the light-emitting surface with passing through the diffuser B and the optical film assembly 10 to that without passing through the diffuser B and the optical film assembly 10.

Compared to the thinner optical film assembly 10, the diffuser B is thicker (about 1.5 mm to 2.0 mm), so that the material cost thereof is more expensive. In addition, since the thickness of the diffuser B is much larger than that of the optical film assembly 10, more energy loss may occur when the light beam R of the light source S passes through the diffuser B, thereby decreasing the brightness of the backlight module 1. To be noted, the optical film assembly 10 and the diffuser B are not drawn in actual relative proportion, and, in fact, the diffuser B is thicker than the optical film assembly 10. In addition, since the backlight module is developed toward larger size, the requirements of light and thin are desired. In the prior art, the diffuser B is manufactured by injection molding or press molding. However, these methods have the limitation on fluidity (viscosity), so the concentration of the diffusion particles can not be increased continuously. Thus, if it is desired to enhance the scatter effect, the total thickness and weight of the diffuser B must be increased. This will increase the entire thickness of the backlight module 1 and affect the assembling cost and design cost of the LCD device.

Therefore, it is an important subject to provide a light emitting unit and its optical film assembly that can increase the light scatter effect, decrease the thickness and weight, and reduce the cost.

### SUMMARY OF THE INVENTION

In view of the foregoing, the present invention is to provide a light emitting unit and an optical film assembly thereof that can increase the light scatter effect, decrease the thickness and weight, and reduce the cost.

To achieve the above, the present invention discloses an optical film assembly, which is applied to a light emitting unit. The light emitting unit has at least two light sources emitting light beams respectively. The optical film assembly includes a first prism element and a first diffusion element. The first prism element, which is a sheet thinner than 0.5 mm, has a first substrate and at least one first prism layer disposed on the first substrate. The first diffusion element, which is a sheet thinner than 0.5 mm, is disposed adjacent to the first prism element. The light beams are emitted to the first prism element or the first diffusion element directly. The light sources have a plurality of projection points projected to a light-emitting surface of the optical film assembly, and the gain of each of the projection points is less than 1.

In addition, the present invention also discloses a light emitting unit, which includes at least two light sources and an optical film assembly. The light sources emit light beams respectively, and the light beams are emitted to the optical film assembly directly. The light sources have a plurality of projection points projected to a light-emitting surface of the optical film assembly, and the gain of each projection point is less than 1. The optical film assembly is disposed adjacent to the light sources and includes a first prism element and a first diffusion element. The first prism element, which is a sheet thinner than 0.5 mm, has a first substrate and at least one first prism layer disposed on the first substrate. The first diffusion element, which is a sheet thinner than 0.5 mm, is disposed adjacent to the first prism element.

As mentioned above, in the light emitting unit and optical film assembly of the present invention, the light beams are directly emitted from the light sources to the first prism or diffusion element, which has a thickness of 0.5 mm, so as to make the light beams more uniform. Compared with the prior art, the optical film assembly of the invention, which is used to diffuse the light beams emitted from the light sources and make it more uniform, is much thinner, so that the material cost can be reduced and the energy loss after passing through the sheets can be decreased, thereby increasing the lighting brightness of the light emitting unit.

Moreover, the scatter function of the optical film assembly can be enhanced by the structural change of the optical film assembly. For example, each prism element may include two prism layers, the substrate of the diffusion element may be doped with diffusion materials, the shape of the prism element may be changed, or a second prism sheet and a second diffusion sheet may be added. In the invention, when the ratio of the distance between the light source to the optical film assembly to the interval between the light sources is smaller than 0.65, which means D/P<0.65, the light emitting unit can serve as a plane light source. In addition, each light source has a plurality of projection points projected to the light-emitting surface of the optical film assembly, and the gain of each projection point is less than 1. This means that the optical film assembly can have the light-splitting effect so as to increase the light intensity at the place, which is not in front of the light-emitting surface. Furthermore, the invention can increase the light diffusion effect of the light emitting unit by way of stacking or attaching (roller to roller) a plurality of optical sheets. This can increase the throughput of the product, decrease the material cost, and reduce the weight of the light emitting unit.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration of a conventional backlight module;

FIG. 2A is a schematic illustration of a light emitting unit according to a first embodiment of the present invention;

FIG. 2B is a diagram showing the light intensity of the light emitting unit without the optical film assembly;

FIG. 3 is a schematic illustration of another light emitting unit according to the first embodiment of the present invention;

FIGS. 4A to 4C are schematic illustrations showing the cross-sections of the first prism elements of different aspects;

FIGS. 5A to 5D are three-dimensional illustrations of the first prism elements of different aspects;

FIG. 6 is a schematic illustration of another first diffusion element;

FIG. 7A is a schematic illustration of a light emitting unit according to a second embodiment of the present invention;

FIG. 7B is a schematic illustration of another light emitting unit according to the second embodiment of the present invention;

FIG. 8 is a schematic illustration of a light emitting unit according to a third embodiment of the present invention;

FIG. 9A is a schematic illustration of a light emitting unit according to a fourth embodiment of the present invention;

FIGS. 9B to 9C are schematic illustrations of the light emitting units of different aspects according to the fourth embodiment of the present invention;

FIG. 10 is a schematic illustration of another light emitting unit according to the fourth embodiment of the present invention;

FIG. 11 is a schematic illustration of yet another light emitting unit according to the fourth embodiment of the present invention; and

FIG. 12 is a schematic illustration of a light emitting unit according to a fifth embodiment of the present invention.

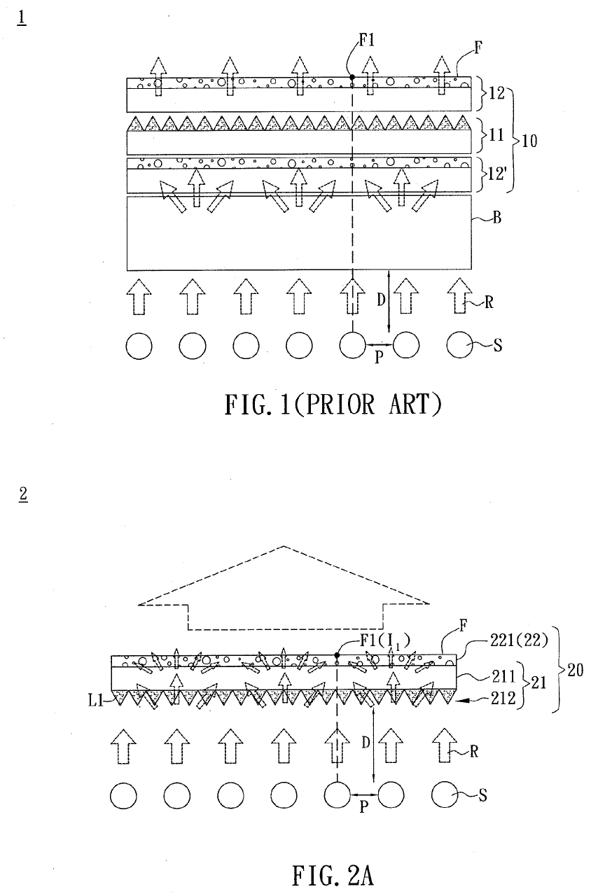

### DETAILED DESCRIPTION OF THE INVENTION

The present invention will be apparent from the following detailed description, which proceeds with reference to the accompanying drawings, wherein the same references relate to the same elements.

### First Embodiment

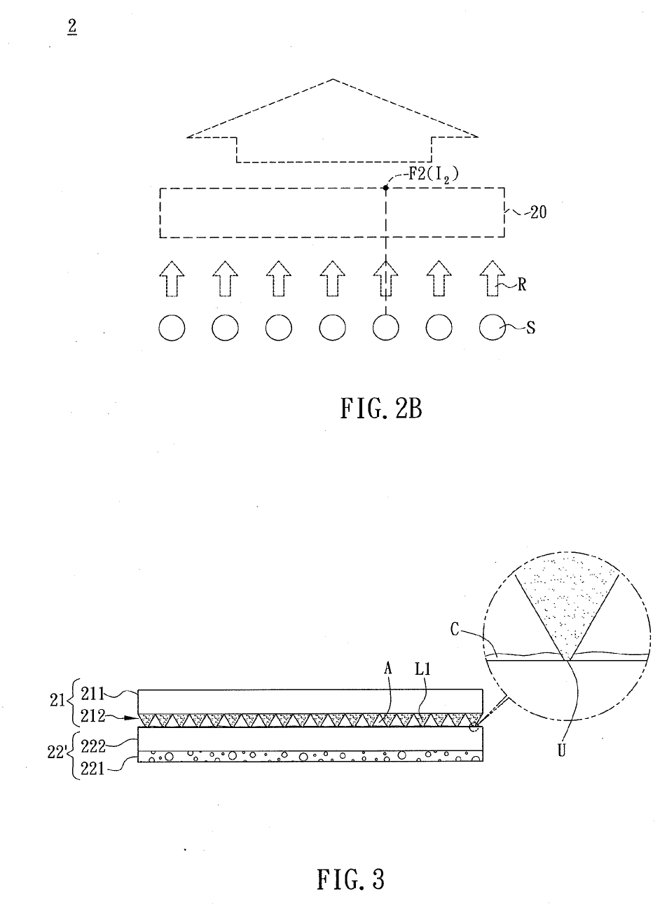

With reference to FIG. 2A, a light emitting unit 2 according to a first embodiment of the present invention includes at least two light sources S and an optical film assembly 20. In the embodiment, the light emitting unit 2 is, for example, a direct-type backlight module and has a plurality of light sources S. Of course, the light emitting unit 2 can also be an illumination device, an outdoor media board or a light source module of other electronic device.

The light source S can be a cold cathode fluorescent lamp (CCFL), a hot cathode fluorescent lamp (HCFL), an external electrode fluorescent lamp (EEFL), a light-emitting diode (LED) or an organic light-emitting diode (OLED). In this embodiment, the light source S is a CCFL for example, and the light sources S emit light beams R, respectively.

The optical film assembly 20 is disposed adjacent to the light sources S and includes a first prism element 21 and a diffusion element 22. The light beams R are emitted from the light sources S to the first prism element 21 or the first diffusion element 22 directly. In the following description, the light beams R are emitted to the first prism element 21 for example.

The first prism element 21 can be a sheet thinner than 0.5 mm and have a first substrate 211 and at least one first prism layer 212 disposed on the first substrate 211. In this embodiment, the first prism element 21 has only one first prism layer 212. The first prism element 21 is attached or stacked to the first diffusion element 22 through a surface of the first substrate 211.

The material of the first substrate 211 can be at least one of polystyrene (PS), polycarbonate (PC), methylstyrene (MS), polymethylmethacrylate (PMMA) or polyethylene terephthalate (PET). The first prism layer 212 can be integrally formed with the first substrate 211 by way of hot rolling or hot pressing. Alternatively, the first prism layer 212 can be made of UV curing resin or thermosetting resin, which is disposed on the first substrate 211 by rolling and then cured by UV light. In addition, the first prism layer 212 includes a plurality of first prisms L1. The shape of the cross-section of the first prism L1 can be selected from the group consisting of arc, semicircle, sector, triangle, polygon, irregular shape and the combination thereof. In the present embodiment, the shape of the cross-section of the first prism L1 is triangle.

The first diffusion element 22 can be a sheet thinner than 0.5 mm and be disposed adjacent to the first prism element 21. The first diffusion element 22 can be formed by press molding, press-spread molding, printing or coating. In the embodiment, the first diffusion element 22 has a first diffusion layer 221 formed on the first substrate 211 of the first prism element 21. The first diffusion layer 221 includes a diffusion material, which includes at least one of TiO₂, BaSO₄ and organic diffusion particles.

According to the prisms of the first prism layer 212 of the first prism element 21, the peak of the strongest light intensity can be split and then form the image on the first diffusion element 22. Next, the first diffusion layer 221 of the first diffusion element 22 can make the light beams be more uniformly diffused, thereby transforming the line light source of the light beams R emitted from the light sources S into the uniform plane light source. According to the optical film assembly 20 of the embodiment, the plane light source can be provided as the ratio of D/P is less than 0.65, which is smaller than the required ratio of D/P in the prior art, so that the thickness of the light emitting unit 2 can be decreased. Herein, “D” represents the distance between the light source S and the optical film assembly 20, and “P” represents the interval between the light sources S. In addition, each light source S has a plurality of projection points F1 projected to a light-emitting surface F of the optical film assembly 20, and the gain of each projection point F1 is less than 1. Referring to FIGS. 2A and 2B, the definition of the “gain” G is the ratio of the light intensity I₁ of the projection point F1 perpendicular to the light-emitting surface with passing through the optical film assembly 20 to the light intensity I₂ of the projection point F1 perpendicular to the light-emitting surface without passing through the optical film assembly 20. That is, G=I₁/I₂. As mentioned above, the optical film assembly 20 can have the light-splitting effect with respective to the light beams so as to increase the light intensity at the place, which is not in front of the light-emitting surface F.

With reference to FIG. 3, the relative positions of the first prism element 21 and the first diffusion element 22′ are not limited, and for example, the first diffusion element 22′ can be disposed at the place closer to the light source S. In this embodiment, the first diffusion element 22′ has a first diffusion layer 221 and a first diffusion substrate 222. The material of the first diffusion substrate 222 may be the same as that of the first substrate 211, such as at least one of PS, PC, MS, PMMA and PET. The first prism layer 212 is combined with the first diffusion substrate 222. At least a part of the first prisms L1 on the first prism layer 212 have a top surface U, respectively. Based on the additional process or design of mold, at least a part of the top surfaces U are disposed on the same plane, so that the first diffusion substrate 222 coated with the adhesive C can be easily combined with the top surfaces U. As shown in FIG. 3, all first prisms L1 on the first prism layer 212 have a top surface U, respectively, and the top surfaces U are disposed on the same plane and combined with the first diffusion substrate 222 for example. To be noted, although the adhesive is not shown in other figures, it is still needed between two elements for adhesion. After the first prism layer 212 and the first diffusion substrate 222 are combined, a plurality of air gaps A are formed between the first prism element 21 and the first diffusion element 22′. After the light beams emitted from the light sources S enter the first diffusion element 22′ to adjust the light shape, most of the light beams outputted from the first diffusion element 22′ travel through the air gaps A and then enter the first prism element 21. According to the differences in structure and refraction between the air gap A and the first prism element 21, the light shape and light intensity can have the energy redistribution in three-dimension, so that the light beams emitted from the first prism element 21 can be scattered to be more uniform.

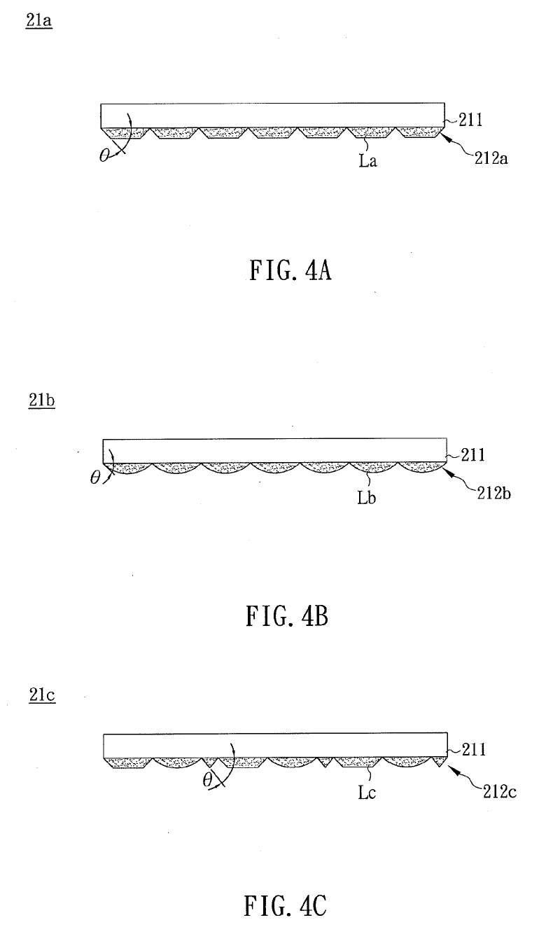

With reference to FIGS. 4A to 6, the different aspects of the first prism elements 21a, 21b and 21c and the first diffusion element 22a will be described hereinafter.

FIGS. 4A to 4C are schematic illustrations showing the cross-sections of the first prism layers in the first prism element of different aspects. As shown in FIG. 4A, the first prisms La are trapezoids and construct the first prism layer 212a. As shown in FIG. 4B, the first prisms Lb are arcs and construct the first prism layer 212b. As shown in FIG. 4C, the first prisms Lc are triangles, arcs and trapezoids so as to construct the first prism layer 212c. To be noted, the design of the cross-sections of the first prism layers 212a, 212b and 212c must satisfy the condition that the included angle between the first substrate 211 and each first prism La, Lb or Lc is not greater than 90 degrees.

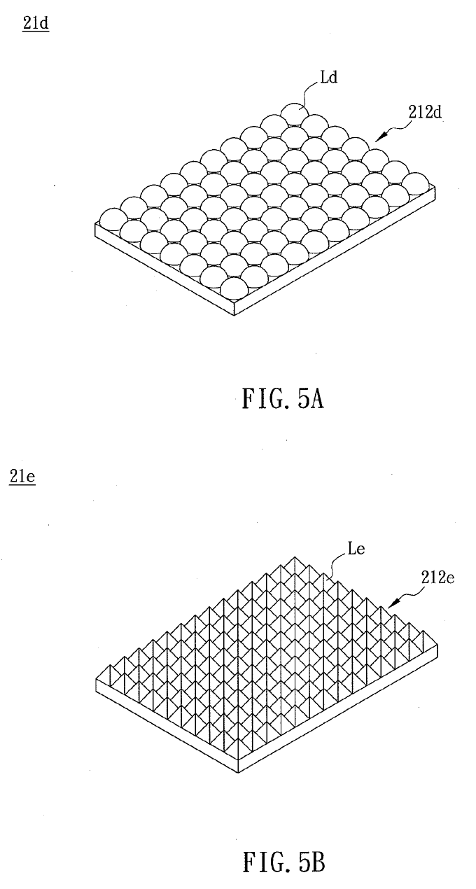

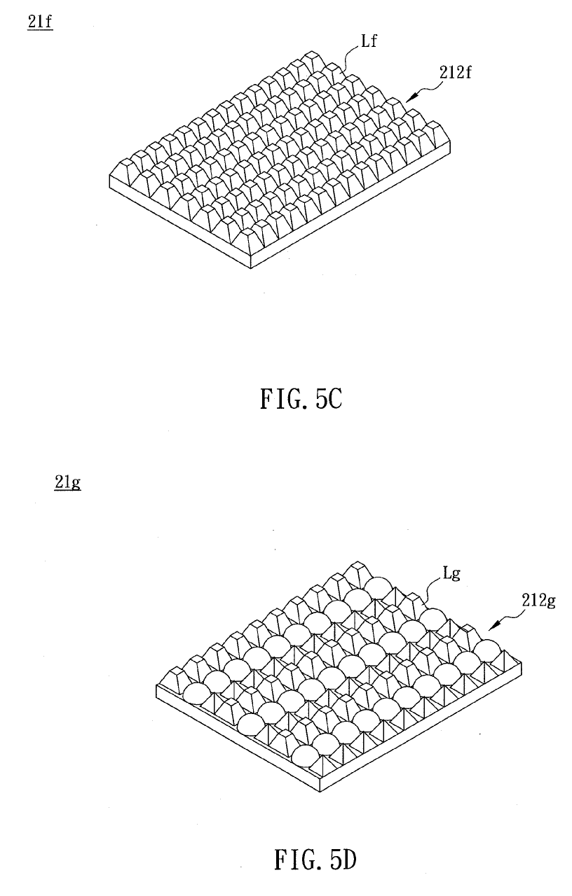

FIGS. 5A to 5D are three-dimensional illustrations of the first prism elements 21d, 21e, 21f and 21g of different aspects. The shape of the first prism Ld, Le, Lf and Lg of the first prism layer 212d can be a ball, a hemisphere (see FIG. 5A), a column, a pyramid (see FIG. 5B), a wedge (see FIG. 5C) or composed of different shapes (see FIG. 5D). To be noted, the shape, size, combination and order of the first prisms Ld, Le, Lf and Lg are not limited, and the priority consideration is to enhance the scatter effect of the first prism elements 21d, 21e, 21f and 21g.

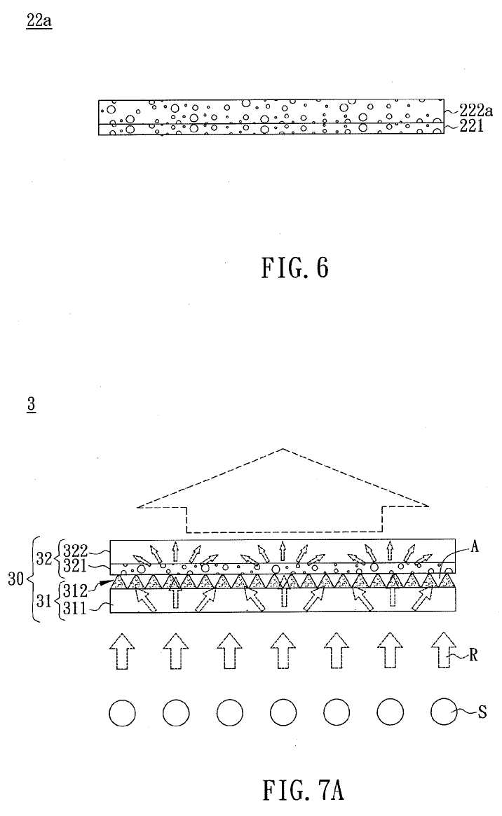

FIG. 6 is a schematic illustration of another first diffusion element 22a. Compared with the first diffusion element 22′ of FIG. 3, the first diffusion layer 221 of the first diffusion element 22a can be doped with the same diffusion material as the first diffusion layer 221, so that the light beams can be diffused more uniformly.

### Second Embodiment

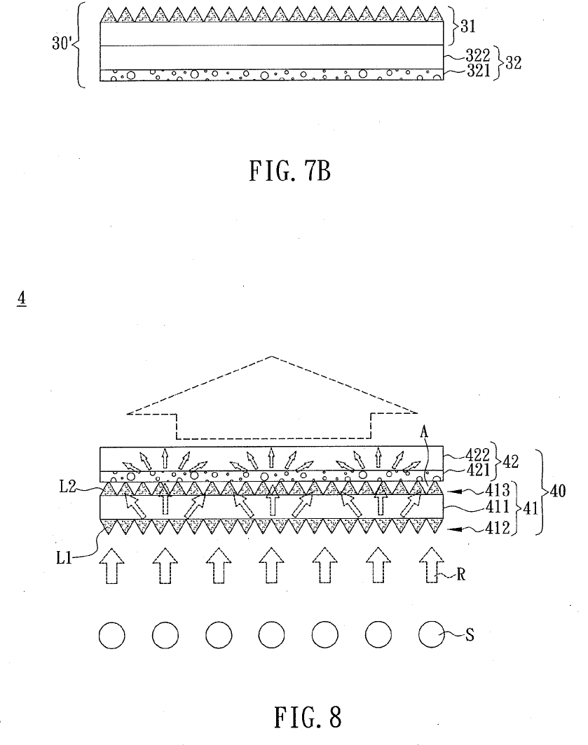

With reference to FIG. 7A, the difference between the light emitting unit 3 of the second embodiment and the light emitting unit 2 of the first embodiment is in that the first prism layer 312 of the first prism element 31 in the optical film assembly 30 is disposed away from the light source S, and a plurality of air gaps A are formed between the first prism element 31 and the first diffusion element 32.

In this embodiment, the first prism element 31 and the first diffusion element 32 can also make the light beams R emitted from the light sources S be diffused more uniformly, so that the light beams R emitted from the light sources S can be transformed from the line light source to the uniform plane light source. In addition, referring to the optical film assembly 30′ shown in FIG. 7B, the first prism element 31 can be disposed at the other side of the first diffusion element 32, and the same effect can be obtained.

In the first diffusion element 32 of this embodiment, accepting the first diffusion layer 321, the first diffusion substrate 322 can also be doped with the diffusion material to enhance the scatter effect.

### Third Embodiment

With reference to FIG. 8, the difference between the light emitting unit 4 of the third embodiment and the light emitting unit of the previous embodiments is in that the first prism element 41 of the optical film assembly 40 further includes a second prism layer 413, and the first substrate 411 is disposed between the first prism layer 412 and the second prism layer 413. A plurality of air gaps A are formed between the first prism element 41 and the first diffusion element 42. To be noted, the first prisms L1 of the first prism layer 412 and the second prisms L2 of the second prism layer 413 can be formed with the same or different shapes, and the first prisms L1 and the second prisms L2 of this embodiment are triangles for example.

Since the first prism element 41 includes two prism layers 412 and 413, the scatter effect of the first prism element 41 regarding to the light beams R emitted from the light sources S can be further enhanced.

In addition, similar to the previous embodiment, the first prism element 41 can also be disposed at the other side of the first diffusion element 42, and the first diffusion substrate 422 of the first diffusion element 42 can also be doped with the diffusion material as the first diffusion layer 421 to enhance the scatter effect.

### Fourth Embodiment

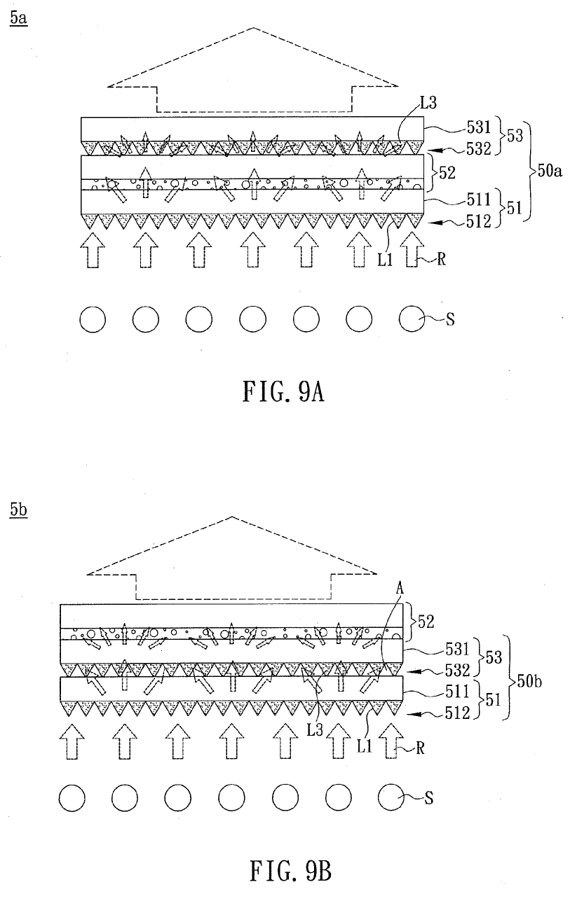

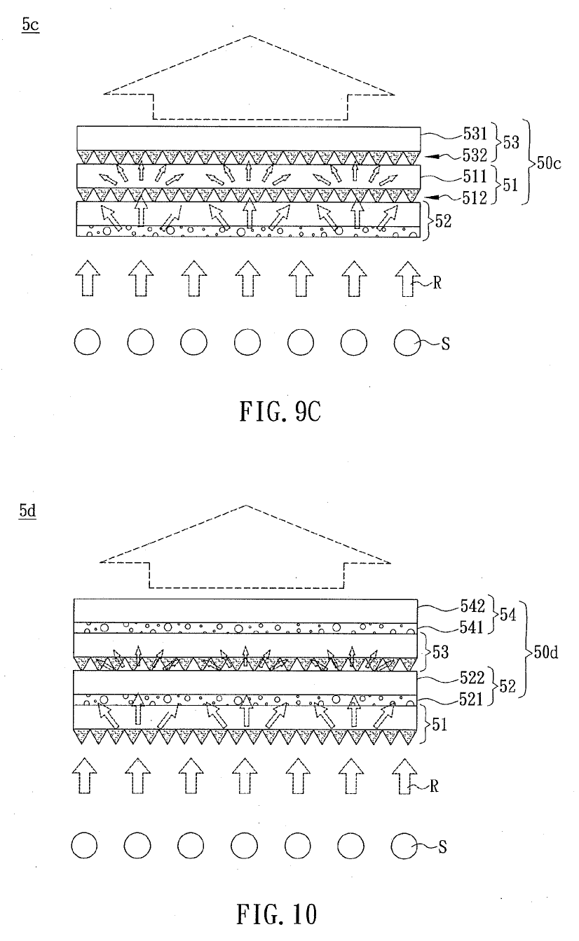

With reference to FIG. 9A, the difference between the light emitting unit 5a of the fourth embodiment and the light emitting unit of the previous embodiments is in that the optical film assembly 50a further includes a second prism element 53 disposed adjacent to the first prism element 51 or the first diffusion element 52. In the present embodiment, the second prism element 53 is disposed adjacent to the first diffusion element 52, so that the first diffusion element 52 is disposed between the first prism element 51 and the second prism element 53. The second prism element 53 includes a second substrate 531 and a third prism layer 532.

The material of the second substrate 531 may be the same as that of the first substrate 511, such as at least one of PS, PC, MS, PMMA and PET. The third prism layer 532 can also be the same as the first prism layer 512, which can be integrally formed with the second substrate 531 by way of hot rolling or hot pressing, or can be made of UV curing resin or thermosetting resin, which is disposed on the second substrate 531 by rolling and then cured by UV light. In addition, the third prism layer 532 includes a plurality of third prisms L3. The shape of the cross-section of the third prism L3 can be selected from the group consisting of arc, semicircle, sector, triangle, polygon, irregular shape and the combination thereof. In the present embodiment, the shape of the cross-section of the third prism L3 is triangle. To be noted, the shape of the third prism L3 may be the same as or different from that of the first prism L1, and the material of the second substrate 531 may be the same as or different from that of the first substrate 511. In the embodiment, the shape of the third prism L3 is the same as that of the first prism L1, and the material of the second substrate 531 is the same as that of the first substrate 511.

In addition, FIGS. 9B and 9C are schematic illustrations of the light emitting units 5b and 5c of different aspects with different arrangements of the first prism element 51 the first diffusion element 52 and the second prism element 53. In FIG. 9B, the second prism element 53 is disposed between the first diffusion element 52 and the first prism element 51. In FIG. 9C, the first prism element 51 is disposed between the first diffusion element 52 and the second prism element 53.

It is noted that the first prism layer 512 and the third prism layer 532 can be disposed away from the light sources S, and a plurality of air gaps A can be formed as attaching or stacking the prism layers 512 and 532 to the surface of any substrate. In addition, the second prism element 53 may include two prism layers, which have the same or different cross-section shapes as that of the above-mentioned first prism element 41. In the embodiment, the prisms L1 and L3 are, for example, triangles. The various aspects of the structures of the first prism element 51 and the second prism element 53 are described in the previous embodiments, so the detailed descriptions thereof will be omitted.

With reference to FIG. 10, the optical film assembly 50d of the light emitting unit 5d of the present embodiment further includes a second diffusion element 54, which is disposed adjacent to the first prism element 51, the first diffusion element 52 or the second prism element 53. In this embodiment, the second diffusion element 54 is disposed adjacent to the second prism element 53 for example. Similar to the first diffusion element 52, the second diffusion element 54 can be formed by press molding, press-spread molding, printing or coating. In the embodiment, the second diffusion element 54 has a second diffusion layer 541 and a second diffusion substrate 542.

In this embodiment, the material of the second diffusion substrate 542 may be the same as that of the first diffusion substrate 522, such as at least one of PS, PC, MS, PMMA and PET. The second diffusion layer 541 includes a diffusion material, which includes at least one of TiO₂, BaSO₄ and organic diffusion particles. The second diffusion layer 541 is formed on a surface of the second diffusion substrate 542 by printing or coating. To be noted, the second diffusion layer 541 and the first diffusion layer 521 can be made of the same or different materials, and the first diffusion substrate 542 and the second diffusion substrate 522 can also be made of the same or different materials. The structure changes and arrangements of the first prism element 51, the first diffusion element 52, the second prism element 53 and the second diffusion element 54 are not limited to this embodiment, and they can have various aspects according to the previous embodiments.

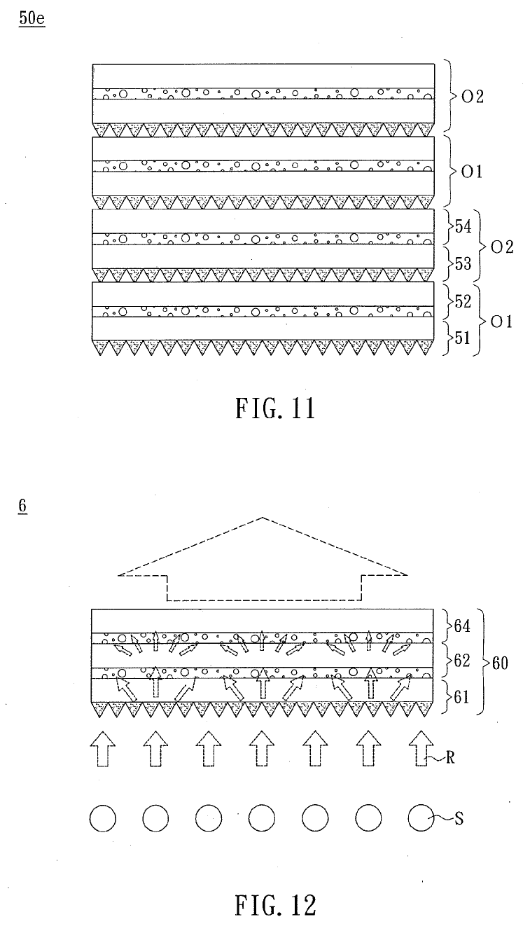

With reference to FIG. 11, in the optical film assembly 50e, the first prism element 51 and the first diffusion element 52 form a first optical set O1, and the second prism element 53 and the second diffusion element 54 form a second optical set O2. The first optical set O1 and the second optical set O2 can be stacked or attached to each other so as to enhance the scatter effect. In this embodiment, the optical film assembly 50e includes two first optical sets O1 and two second optical sets O2, which are alternately stacked. To be noted, the arrangement of the optical sets O1 and O2 is not limited and the structure of each of the optical sets O1 and O2 can be changed according to the various aspects in the previous embodiments, and the detailed descriptions thereof will be omitted.

### Fifth Embodiment

With reference to FIG. 12, the difference between the light emitting unit 6 of the fifth embodiment and the light emitting unit of the previous embodiments is in that the optical film assembly 60 further includes a second diffusion element 64 disposed adjacent to the first prism element 61 or the first diffusion element 62. In the present embodiment, the second diffusion element 64 is disposed adjacent to the first diffusion element 62 so as to enhance the scatter effect of the optical film assembly 60.

To be noted, the arrangement of the first prism element 61, the first diffusion element 62 and the second diffusion element 64 is not limited, and the structure thereof can be changed according to the various aspects in the previous embodiments.

Referring to FIG. 2A again, the present invention also discloses an optical film assembly 20, which is applied to a light emitting unit 2. The light emitting unit 2 has at least two light sources S for emitting light beams R respectively. The light beams R are emitted to the optical film assembly 20 directly. The light sources S have a plurality of projection points F1 projected to a light-emitting surface F of the optical film assembly 20, and the gain of each projection point F1 is less than 1. The optical film assembly 20 includes a first prism element 21 and a first diffusion element 22. The first prism element 21, which is a sheet thinner than 0.5 mm, has a first substrate 211 and at least one first prism layer 212 disposed on the first substrate 211. The first diffusion element 22, which is a sheet thinner than 0.5 mm, is disposed adjacent to the first prism element 21.

The various aspects of the optical film assembly 20 have been described in the above-mentioned embodiments, such as the optical film assembly 30, 30′, 40, 50a, 50b, 50c, 50d, 50e or 60, so the detailed descriptions thereof will be omitted.

To sum up, in the light emitting unit and optical film assembly of the present invention, the light beams are directly emitted from the light sources to the first prism or diffusion element, which has a thickness of 0.5 mm, so as to make the light beams more uniform. Compared with the prior art, the optical film assembly of the invention, which is used to diffuse the light beams emitted from the light sources and make it more uniform, is much thinner, so that the material cost can be reduced and the energy loss after passing through the sheets can be decreased, thereby increasing the lighting brightness of the light emitting unit.

Moreover, the scatter function of the optical film assembly can be enhanced by the structural change of the optical film assembly. For example, each prism element may include two prism layers, the substrate of the diffusion element may be doped with diffusion materials, the shape of the prism element may be changed, or a second prism sheet and a second diffusion sheet may be added. In the invention, when the ratio of the distance between the light source to the optical film assembly to the interval between the light sources is smaller than 0.65, which means D/P<0.65, the light emitting unit can serve as a plane light source. In addition, each light source has a plurality of projection points projected to the light-emitting surface of the optical film assembly, and the gain of each projection point is less than 1. This means that the optical film assembly can have the light-splitting effect so as to increase the light intensity at the place, which is not in front of the light-emitting surface. Furthermore, the invention can increase the light diffusion effect of the light emitting unit by way of stacking or attaching (roller to roller) a plurality of optical sheets. This can increase the throughput of the product, decrease the material cost, and reduce the weight of the light emitting unit.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical film assembly for a light emitting unit, wherein the light emitting unit has at least two light sources emitting light beams respectively, the optical film assembly comprising:
a first prism element having a first substrate and at least one first prism layer disposed on the first substrate, wherein the first prism element is a sheet thinner than 0.5 mm; and
a first diffusion element disposed adjacent to the first prism element, wherein the first diffusion element is a sheet thinner than 0.5 mm;
wherein the light beams are emitted to the first prism element or the first diffusion element directly, the light sources have a plurality of projection points projected to a light-emitting surface of the optical film assembly, and the gain of each of the projection points is less than 1.

2. The optical film assembly according to claim 1, wherein the first prism element further comprises a second prism layer, and the first substrate is disposed between the first prism layer and the second prism layer.

3. The optical film assembly according to claim 1, wherein the first prism layer has a plurality of first prisms, at least a part of the first prisms have a top surface, and at least a part of the top surfaces connect to a surface of the first diffusion element.

4. The optical film assembly according to claim 3, wherein at least a part of the top surfaces are positioned on the same surface.

5. The optical film assembly according to claim 1, wherein a plurality of air gaps are formed between the first prism element and the first diffusion element.

6. The optical film assembly according to claim 1, wherein the first prism element is attached or stacked to the first diffusion element through a surface of the first substrate.

7. The optical film assembly according to claim 1, Per comprising:
a second prism element disposed adjacent to the first prism element or the first diffusion element.

8. The optical film assembly according to claim 7, wherein the second prism element has a second substrate and at least one third prism layer disposed on the second substrate.

9. The optical film assembly according to claim 7, further comprising:
a second diffusion element disposed adjacent to the first prism element, the second prism element or the first diffusion element.

10. The optical film assembly according to claim 1, further comprising:
a second diffusion element disposed adjacent to the first prism element or the first diffusion element.

11. A light emitting unit, comprising:
at least two light sources emitting light beams respectively; and
an optical film assembly disposed adjacent to the light sources, wherein the light beams are emitted to the optical film assembly directly, the light sources have a plurality of projection points projected to a light-emitting surface of the optical film assembly, and the gain of each of the projection points is less than 1, the optical film assembly comprising:
a first prism element having a first substrate and at least one first prism layer disposed on the first substrate, wherein the first prism element is a sheet thinner than 0.5 mm; and
a first diffusion element disposed adjacent to the first prism element, wherein the first diffusion element is a sheet thinner than 0.5 mm.

12. The light emitting unit according to claim 11, wherein the first prism element further comprises a second prism layer, and the first substrate is disposed between the first prism layer and the second prism layer.

13. The light emitting unit according to claim 11, wherein the first prism layer has a plurality of first prisms, at least a part of the first prisms have a top surface, and at least a part of the top surfaces connect to a surface of the first diffusion element.

14. The light emitting unit according to claim 13, wherein at least a part of the top surfaces are positioned on the same surface.

15. The light emitting unit according to claim 11, wherein a plurality of air gaps are formed between the first prism element and the first diffusion element.

16. The light emitting unit according to claim 11, wherein the first prism element is attached or stacked to the first diffusion element through a surface of the first substrate.

17. The light emitting unit according to claim 11, wherein the optical film assembly further comprises:
a second prism element disposed adjacent to the first prism element or the first diffusion element.

18. The light emitting unit according to claim 17, wherein the second prism element has a second substrate and at least one third prism layer disposed on the second substrate.

19. The light emitting unit according to claim 17, wherein the optical film assembly further comprises:
a second diffusion element disposed adjacent to the first prism element, the second prism element or the first diffusion element.

20. The light emitting unit according to claim 11, wherein the optical film assembly further comprises:
a second diffusion element disposed adjacent to the first prism element or the first diffusion element.
